(19) United States
(12) Patent Application Publication
(10) Pub. No.: US 2008/0126426 A1
(43) Pub. Date: May 29, 2008

(54) Adaptive voice-feature-enhanced matchmaking method and system

(76) Inventors: Alphan Manas, Istanbul (TR); Volkan Ozturk, Istanbul (TR); Ufuk Emekli, Istanbul (TR); Gozde Bozdagi Akar, Ankara (TR); Burcu Kepenekci, Ankara (TR); Murat Askar, Ankara (TR); Tolga Ciloglu, Ankara (TR)

Correspondence Address: JANSSON SHUPE & MUNGER LTD., 245 MAIN STREET, RACINE, WI, 53403, US

(21) Appl. No.: 11/981,010

(22) Filed: Oct. 31, 2007

Related U.S. Application Data
(60) Provisional application No. 60/863,661, filed on Oct. 31, 2006.

(51) Int. Cl. G06F 17/30

(52) U.S. Cl. 707/104.1; 707/E17.019

(57) ABSTRACT

A computer-based matchmaking method utilizing numerical representations of voice as well facial features to improve matchmaking capabilities, the voice features preferably including articulation quality measures, speed of speech measures, audio energy measures, fundamental frequency measures, and relative audio periods. Certain preferred embodiments include: plastic-surgery-unique anthropometric facial measures to enhance system effectiveness; use of both standard and non-standard facial points identified by Gabor kernel-based filtering; and adapting to user preferences by adjusting system parameters based on user responses to potential matches.

### RELATED APPLICATION

This application is based in part on U.S. Provisional Application 60/863,661, filed on Oct. 31, 2006.

### FIELD OF THE INVENTION

The present invention is related generally to the field of matchmaking or dating services and, more particularly, to computer-based matchmaking methods and systems for matching users with one or more individuals of a universe of individuals based on data associated with the users and the individuals of the universe.

### BACKGROUND OF THE INVENTION

Biometrics, can be identified as the physiological and/or behavioral characteristics that differentiate persons from one another. Biometric measures are useful because, to a large degree, combinations of biometric measures are specific to each person and therefore can be used to distinguish one individual from other individuals. At the present time, biometric systems utilizing visual and/or voice data are used as a means of identification.

Detailed evaluation of persons, using audio and facial biometric attributes is widely utilized by human resources, psychology, criminology specialists. However, since such systems are not automated, results depend the specialists who evaluate the attributes of a subject.

Biometrics can be applied not only to identification of individuals but to the task of matchmaking. One of the matchmaking systems in the prior art is the method disclosed in U.S. Pat. No. 7,055,103 (Lif), entitled “Method of Matchmaking Service.” This patent describes an improved method for matchmaking of a searcher and prospective candidates, including providing an image of each candidate, analyzing the image to define physical characteristics of each of the candidates, and selecting at least one potential match between the searcher and candidates based on the characteristics. Visual data on the physical characteristics of a candidate are obtained and, similarly, the candidate may select certain physical characteristics which are among the preferred physical characteristics of the desired match. Automatic extraction of specific facial and body attributes is mentioned, but a method of doing such extraction is not disclosed. Only visual data for physical characteristics is used; no aural (voice) analysis and aural matching is utilized. Further, the system described by Lif includes the cooperation of at least one “referee,” an individual supplied by the searcher for the purpose of reviewing all or part of the searcher's profile as part of the method.

Another matchmaking system is disclosed in United States published patent application No. 2006/0210125 (Heisele). This patent application discloses a method which matches a description of a face with face images in a database. In the method of this service/system for dating/matchmaking, a partner profile includes a description of a face and a member profile comprises one or more images of a face. Automated extraction of facial features based on a reference overlay technique is disclosed. The matching process between partner and member profiles is a method which matches the description of a face in the partner profile with the face images in the member profiles. Only the images of the members and the partner and, optionally, non-pictorial descriptions of both, are processed; no aural (voice) analysis and matching is carried out.

Another matchmaking system in the prior art is the method disclosed in international patent application WO 2006/053375 A1. The matchmaking method disclosed in this patent application includes the steps of providing biometric data characterizing physical features of the user, providing a database having biometric data characterizing physical features of a plurality of individuals, and comparing the biometric data of the user with at least one individual characterized by biometric data which is at least similar to that of the user and/or a parent of the user. The biometric data utilized for such comparisons is typically based on a group of nodal points identified on the human face or some other useful measures such as eye size and shape and chin size and shape. No aural (voice) analysis or aural matching is utilized. Additionally, this method does not contain a way to improve the matching process through user feedback; the selected potential match or matches are not evaluated by the user to inform the system and allow it to learn from this feedback.

### OBJECTS OF THE INVENTION

The primary object of this improved matchmaking system invention to provide a matchmaking system which obtains better matches between an individual and individuals from a database of a universe of users by using both visual and audio data to find potential matches.

Another object of this invention is to provide an improved matchmaking system which better utilizes anatomical features to characterize facial anatomy in ways particularly useful for matchmaking.

Another object of this invention is to provide an improved matchmaking system which better utilizes the preferences of an individual user, in ways particularly useful for matchmaking.

Yet another object of this invention is to provide an improved matchmaking system with a self-enhancing capability that improves the representation of user preferences during the matching processes.

Still another object of this invention is to provide an improved matchmaking system which, represents each individual user with data from a substantially larger number of physical measurements, for improved matching.

Yet another object of this invention is to provide an improved matchmaking system which increases the efficiency of the match-searching process.

These and other objects of the invention will be apparent from the following descriptions and from the drawings.

### SUMMARY OF THE INVENTION

The improved matchmaking method described herein overcomes the shortcomings of prior methods and systems and achieves the objects of the invention. The matchmaking method is of the type which matches a user with one or more individuals of a universe of individuals in a matchmaking system utilizing data in a database, such data being associated with the user and with the individuals of the universe and including at least metadata and personality data.

The matchmaking method improvement of this invention includes the steps of: (a) obtaining recorded voice data and facial-image data for the user and for the individuals of the universe; (b) computing numerical representations of voice and facial features of the user and of the individuals of the universe and store them in the database; (c) obtaining preference-data sets for the user and for the individuals of the universe; (d) computing numerical representations of the voice and facial features of the preference-data sets; and (e) searching the database for at least one match between the numerical representations associated with the individuals of the universe and those associated with the preference-data set of the user, such that one or more individuals of the universe are selected as matches for the user. This invention is based in part on the discovery that numerical representations of voice, as opposed to mere subjective listening, greatly enhances the capabilities of computerized matchmaking.

In a preferred embodiment of the inventive matchmaking method, the computing of numerical representations of voice features includes computing at least one of: (a) articulation quality measures; (b) speed of speech measures; (c) audio energy measures; (d) fundamental frequency measures; and (e) relative audio periods. In highly-preferred embodiments of the method, the step of obtaining of the preference-data set of the user includes the user's providing data on the degree the user likes the sample voices.

In preferred embodiments of the improved matchmaking method, the computing of numerical representations of facial features includes measuring a plurality of anatomical features. In highly-preferred embodiments of the method, the plurality of anatomical features includes a plurality of plastic-surgery-unique anthropometric facial measures. This invention is based in part on the discovery that certain anthropometric facial measures of a type heretofore not thought to be useful in face recognition systems are in fact useful in matchmaking.

In some preferred embodiments, the plastic-surgery-unique anthropometric facial measures are selected from among: (a) the angle between nose-chin and nose-forehead; (b) nose-upper lip angle; (c) nose-hook angle; (d) the backwards angle of the forehead and the nose angle; (e) the distance between the side eye limbus and the peak point of the eyebrow; (f) the ratio of the distance between the inward termination points of the eyes to the distance between the eye cavities; (g) the ratio of the distance between the inward termination points of the eyes to the distance of the nose width; and (h) the lower and upper nose inclination angles.

In other preferred embodiments of the inventive matchmaking method, the computing of numerical representations of facial features includes using Gabor kernels to locate both standard and non-standard feature points having local maxima in the Gabor-kernel images.

In some highly-preferred embodiments of the improved matchmaking method, the step of searching identifies more than one match and the method further includes the additional steps of: (a) prioritizing the selected matches and presenting such prioritized matches to the user; (b) capturing user feedback regarding the prioritized matches; and (c) adjusting the numerical representation of the preference-data set of the user. This self-enhancing capability in the inventive method and system improves the ability of the system to identify matches satisfying the user.

As used herein, the term “universe of individuals” refers to the totality of users registered in the matchmaking system and being candidates to be matched by another user.

As used herein, the term “preference-data set” with respect to a user refers to the combined possible-match templates related to the various data classes and representing preferences of the user.

### BRIEF DESCRIPTION OF THE DRAWINGS

The drawings illustrate preferred embodiments which include the above-noted characteristics and features of the invention. The invention will be readily understood from the descriptions and drawings. In the drawings:

FIG. 1 is a flowchart of one embodiment of the inventive matchmaking system.

FIGS. 2 and 3, taken side-by-side, together are a flowchart illustrating the construction of a possible-match template based on voice and facial features.

FIG. 4 is a flowchart illustrating the flow of data into the database system used for the method of this invention.

FIG. 5 is a flowchart of the Human Vision System facial feature extraction process.

FIG. 5 is a flowchart of an individual user registration process.

FIG. 6 is a flowchart illustrating the combining of face data matching with matching of the other types of data utilized.

FIG. 7 is a side view projection (profile) of an exemplary face image.

FIG. 8 is an image of the exemplary face profiled in FIG. 7 with points selected for analysis added to the image.

FIG. 9 illustrates forty Gabor kernels generated for five spatial frequencies and eight orientations.

FIG. 10 is an image of an exemplary face analyzed using the Gabor kernels of FIG. 9 with feature points, extracted by the analysis, added to the image.

FIG. 11 is a schematic profile and front facial view illustrating a number of facial soft tissue points (side and front).

FIG. 12 is a schematic profile of an exemplary face illustrating the angle between the nose-chin line and nose-forehead line.

FIG. 13 is a schematic profile of an exemplary face illustrating the nose-upper lip angle.

FIG. 14 is a schematic profile of an exemplary face illustrating the nose-hook angle.

FIG. 15 is a schematic front view of an exemplary face illustrating the ratio of the distance between the uppermost line of the head and the line parallel to the level of the eyes to the distance between the lowermost line of the chin and the line parallel to the level of the eyes.

FIG. 16 is a schematic frontal view of an exemplary face illustrating the ratio of the distances between trichion, nasion, subnasale and gnathion.

FIG. 17 is a schematic profile of an exemplary face illustrating the ratio of the distance between the bottom of the nose to mid-lip to the distance between the lip clearance and the bottom of the chin.

FIG. 18 is a schematic profile of an exemplary face illustrating the backwards angle of the forehead and the nose angle.

FIG. 19 is a schematic front view of an exemplary face illustrating the distance between the side eye limbus and the peak point of the eyebrow.

FIG. 20 is a schematic front view of an exemplary face illustrating the ratio of the distance between the inward termination points of the eyes to the distance between the eye cavities.

FIG. 21 is a schematic front view of an exemplary face illustrating the ratio of the distance between the inward termination points of the eyes to the nose width.

FIG. 22 is a schematic profile of an exemplary face illustrating the lower and upper nose inclination angles.

FIG. 23 is a schematic partial front view of an exemplary face illustrating the ratio of nose width to mouth width.

### DETAILED DESCRIPTION OF PREFERRED EMBODIMENTS

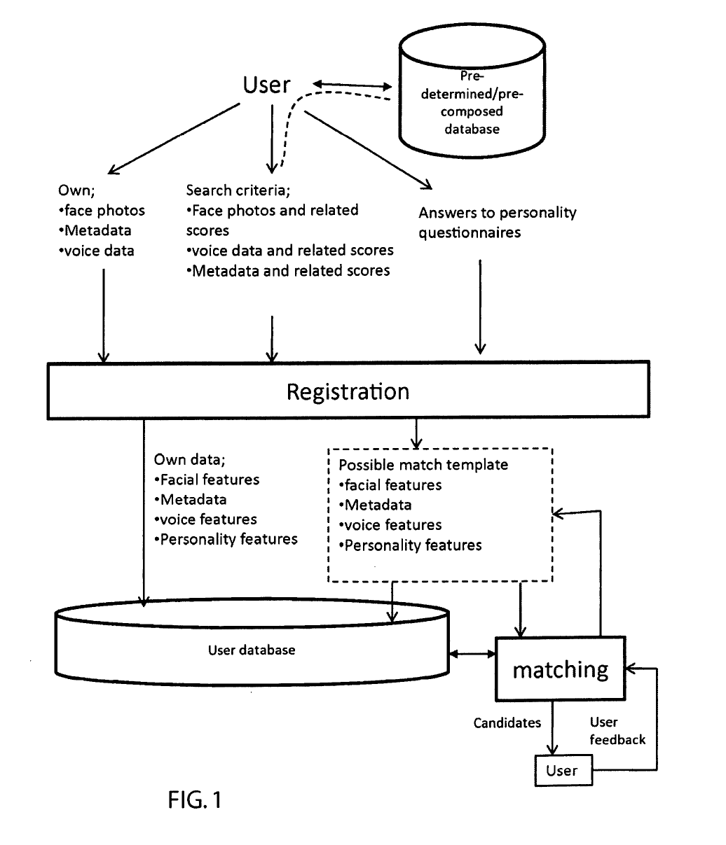

FIGS. 1-6 are various flow charts illustrating operation of a preferred system in accordance with the method of this invention. FIG. 1 is a high-level representation of the entire method and system.

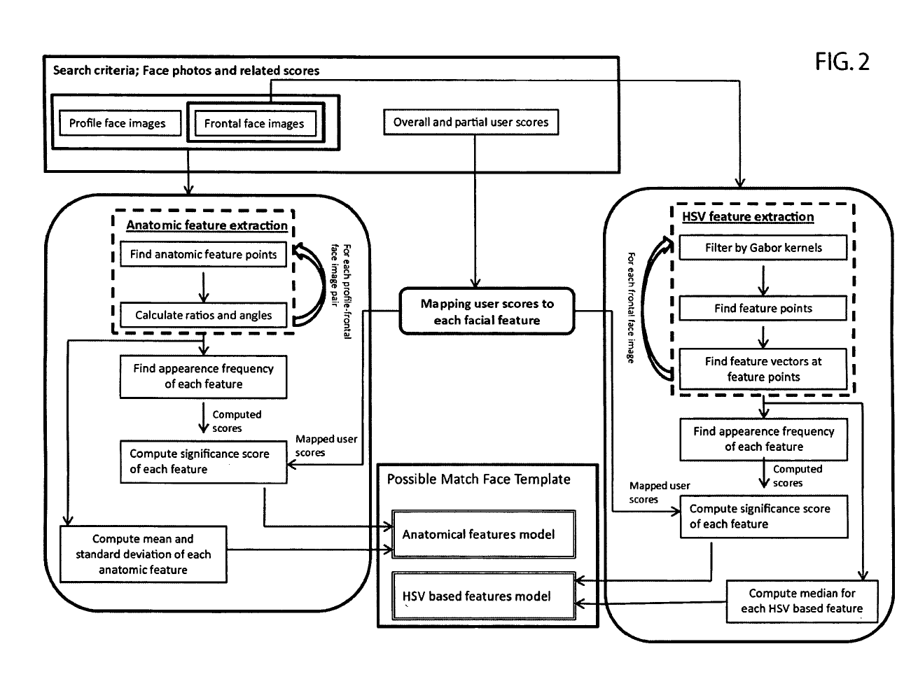

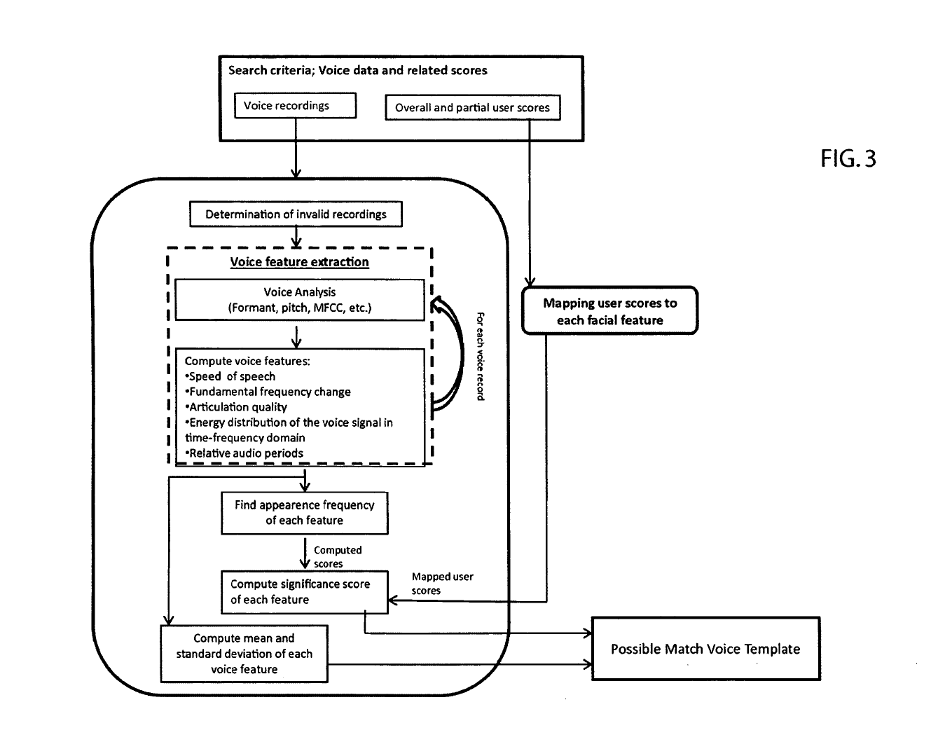

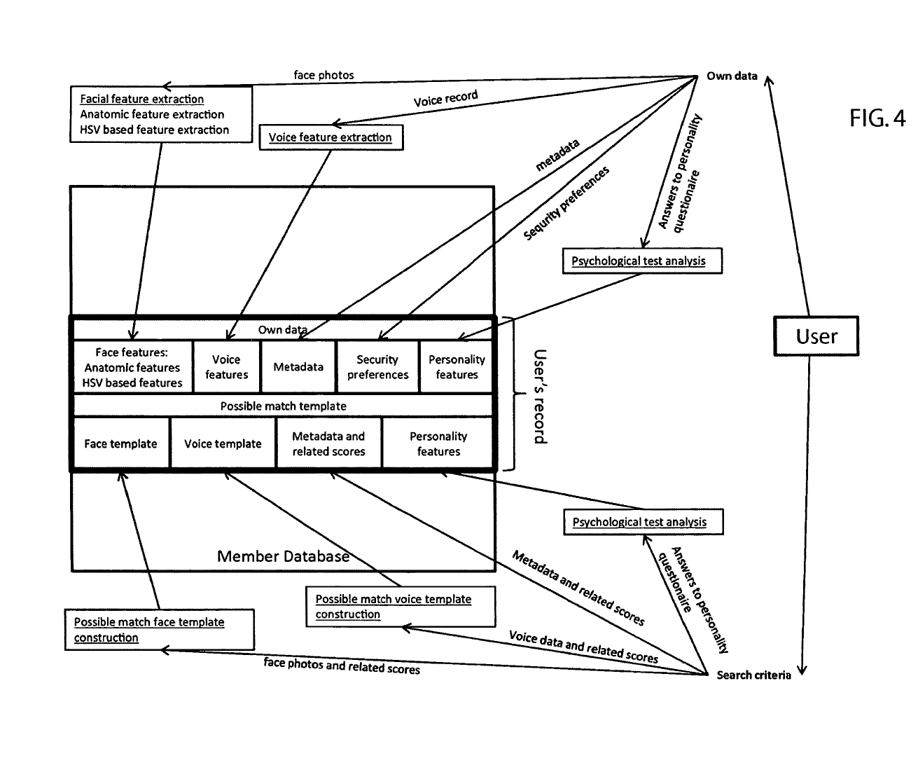

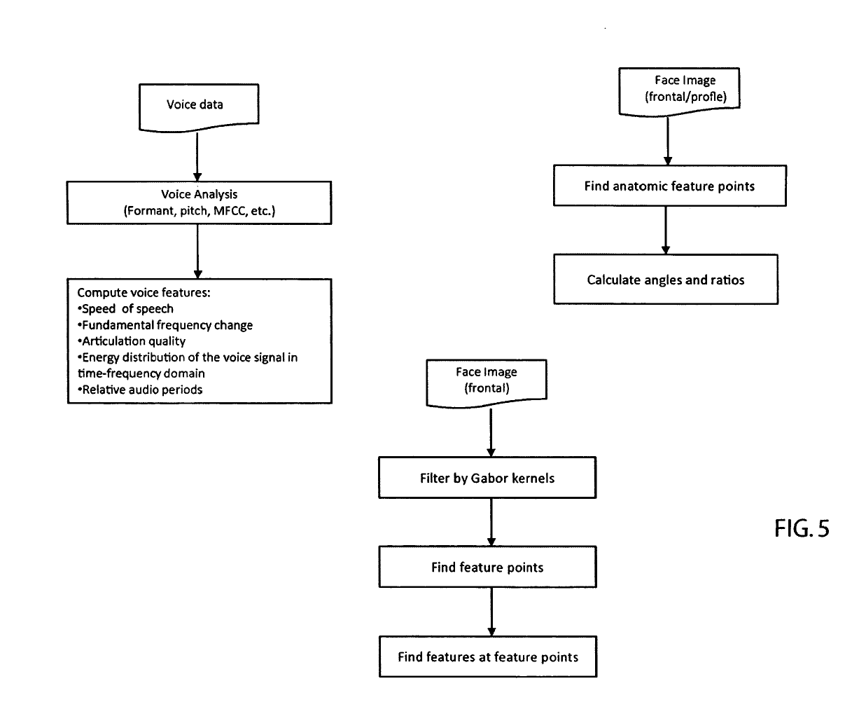

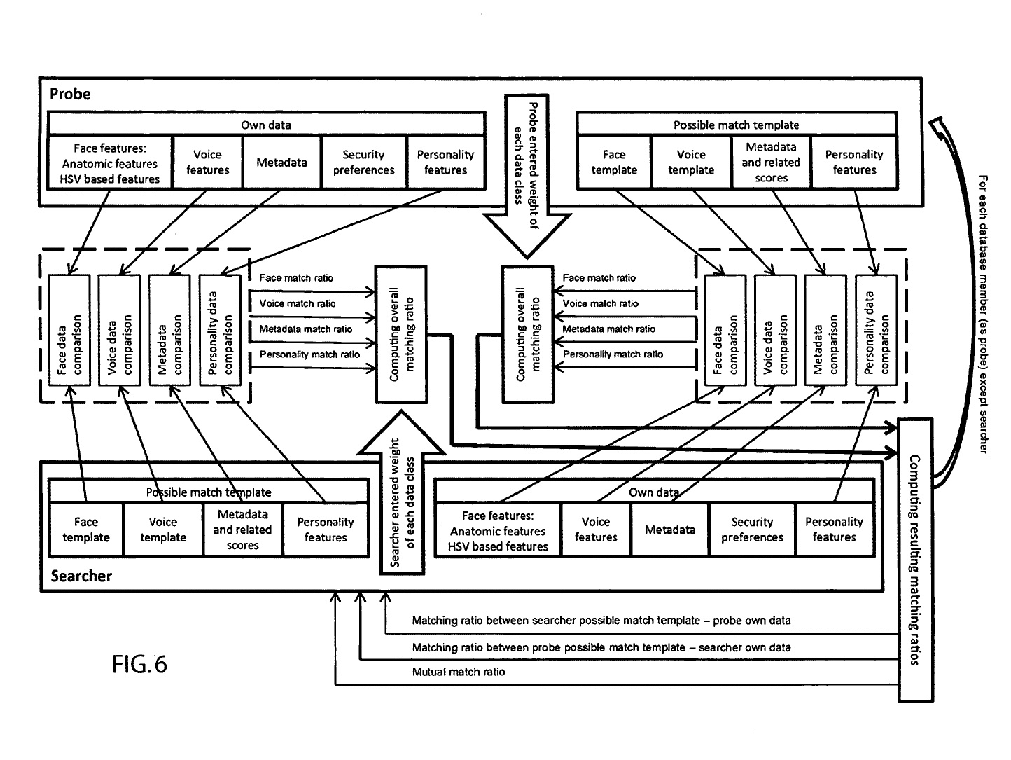

FIGS. 2 and 3 illustrate the generation of possible-match templates based on numerical representations of voice data, anatomical facial features, and human vision system (HVS) facial features. FIG. 4 illustrates the flow of data into the database of the system. FIG. 5 is an additional illustration of the process of computing numerical representations of voice data and facial-image data, and FIG. 6 is a high-level flow chart representing the combining of facial data with the other types of data used by the system. Each of these figures is well annotated for clarity. Details of the method and system of this invention a set forth below.

### Operation of the Method

The present invention is an improved method of matchmaking, and in the following description the term “system” is used to describe the computer-based matchmaking scheme which is applying the inventive method for matchmaking.

A individual user wishing to find one or more individuals who may be a match to the individual user inputs a set of data into the system in the form of responses to questions regarding general information such as age, sex, location, education, income, hobbies, and etc. (herein referred to as metadata), questions in a questionnaire regarding personality traits, and facial image (preferably both front and profile views) and voice recording. The system automatically analyzes the image and audio data to generate a number of numerical representations of facial and aural features which are then used in the matching process.

The individual user also is asked to provide his/her preferences regarding similar information describing a potential match individual and how important the various types of data are to the individual seeking a match. For example, an individual user is able to input or select preferred facial features, i.e. chin, forehead (shape), eyebrows (shape, position, type), eyes (spacing, angle, depth, size of iris and pupil, eyelids (top lids, bottom lids), eyelashes, eye puffs, nose (shape, ridge, width, tip angle, size, nostrils), ears (size, cups and ridges, placement, height), cheeks, mouth (size, angle), lips (size, shape), teeth, jaws, chin, etc. from a system database or user-entered face photos. User can also provide preferred visually related data such as skin color, hair color, eye color, etc.

The above lists of features are not intended to be limiting but only exemplary.

In addition to facial features, features of a voice such as fundamental-frequency (pitch), speed of speech, and energy range are also available from analysis of voices which the individual user selects from a set of prerecorded voices as being preferred or not preferred (likes and/or dislikes). Optionally, the individual user may also express preferences regarding certain features of voice.

The system is able to receive information on a variable number of features, depending on which features the individual user regards as important. An individual user is able to present facial images of one or more other individuals to assist in developing the search criteria, and is asked to provide scores for each such face, including both overall scores for each such face and partial scores for each part (e.g., eyes, lips, nose, etc.) of each such face, thereby increasing the matching accuracy of the system.

The system optionally may present facial images (front and profile) and voice recordings of celebrities and other individuals (volunteer and paid) to the individual user for the purpose of assisting in the process of assessing the preferences of the individual user.

For each pair of front and profile images entered or selected by an individual user, the system computes facial features. Precomputed and prestored features of selected individuals may also be used. For each frontal and profile pair, the system utilizes three kinds of information to generate a set of features called “face search criteria”—facial features, overall scores, and partial scores.

The system synthesizes the face search criteria inputs of the user to generate a “possible-match face template.” The system also analyzes the appearance frequency of each facial feature between face search criteria inputs of the user to find common features and increase their weights at the “possible-match face template.” Finally “possible-match face template” is composed of “possible-match facial feature values” and “possible-match facial feature weights.”

The inventive matchmaking system then automatically analyzes all of the data related to the individual user and all of the data regarding potential matches for the individual user in order generate the basis by which comparisons can be made between such data and the data residing in the system database, such data having been previously analyzed for other users who have entered data regarding themselves.

The system then searches for one or more match to the individual user. Based on the responses of the individual user to the matches presented to him or her, the system, as an adaptive system, adjusts certain numerical values in order to improve the ability of the system to find matches which meet the expectation of the individual user.

The method of this invention forms the facial features in a scientifically proportional manner, when an individual user does not state a preference. For example, if the user does not state any preference regarding nose shape, the system will present the user with potential matches who possess nose shapes and proportions within standards and according to the science of anatomy, as well as visual pleasantness.

The user may enter more than one set of voice data to assist in the formation of the search criteria. The user gives scores to each such set of voice data and may also assign scores to each feature of each voice data to increase the matching accuracy. In a manner similar to the user's providing facial images as described above, when a user enters voice data to develop search criteria, the system may first ask user to assign an “overall score” to that voice, which indicates how much the user likes or dislikes the voice. Next, the system may ask the user to give “partial scores” to each feature of that voice (e.g., speed, tone, etc.) which indicates how much the user likes or dislikes each such voice feature. The system then computes voice features as numerical representations of the voice data, and this data, along with overall and partial scores, are used as “voice search criteria.” The system then synthesizes the voice search criteria inputs of the user to generate a “possible-match voice template.” In this step, the system also analyzes the appearance frequency of each voice feature between voice search criteria inputs of a user to find common features and increase their weights in the “possible-match voice template”. Thus the “possible-match voice template” is composed of “possible-match voice feature values” and “possible-match voice feature weights.”

The system utilizes features of the face and voice search criteria inputs and personality features extracted from the questionnaire about his/her expectations for a match to generate the computed template features. The system presents computer graphics images to obtain confirmation from the user of the computed template features, presents the user the “computed template personality features” and asks user for feedback to refine the final possible-match personality features.

As a result, the database stores for each user the following information which is used for matching: (a) user's own data, including metadata, facial features, voice features, and personality features; and (b) possible-match template data, including possible-match metadata, possible-match face template (feature values and weights), possible-match voice template (feature values and weights), and possible-match character (personality) features.

To further assist in finding a match, a user can also enter weights to indicate the importance of each class of data (metadata, personality features, face features, voice features) for himself/herself.

To find a match for the user, the system compares the user's data with every other users' data (data for the universe of individuals) stored in the system. The system presents matching results by evaluating using three ratios. The first ratio is the ratio between a user's (searcher) possible-match template data and matching user (probe) data which is the similarity measure of how much the probe matches the searcher. The second ratio is the ratio between the matching user's (probe) possible-match template data and the user's (searcher) data, which is the similarity measure of how much the searcher matches the probe. The third ratio, the “mutual match ratio,” is the average of the first two ratios and is a measure of how much the searcher and the probe match each other.

The match results are provided to the user as a percentage of matches in four categories: metadata, face, voice and personality. The user may adjust the percentages that he/she desires in a match based on the potential matches, for example, deciding that the voice is more important than originally thought.

A selected match for the user is informed, and has the opportunity to consider whether the user matches him/her according to his/her given criteria, again expressed as percentage levels. It is then be up to the informed party's discretion whether he/she wishes the system to release his/her personal information to the user.

Finally, the user provides feedback about the matching accuracy by rating the matching results. In this fashion, the system adapts to the user's preferences and updates the possible-match template for that user to provide better matching accuracy for the future searches.

The method can be applied both in a stand-alone website/portal system and as an engine providing services for other websites. In a standalone website/portal application, the system utilizes an interface which may be used with internet browsers in an internet environment. The system establishes an interactive relationship with the users and enables the users to easily access any information and image. Images and voice recording can be provided by webcam/audio interfaces. Other data is easily exchanged in such an application, via questionnaires and other data-gathering means known to those skilled in the art.

In the event that the method is applied to third-party websites/portals (“3^{rd} Party”), personal information may be provided by the third party to the system to perform the matching process. It is also possible to utilize only facial and voice data and provide matches based only on such data. Then a third party can finalize the matching process by adding personal information into the system for final matching.

The system based on the inventive method is supported by image- and voice-capturing hardware (webcam, camera, camera phone etc.) and various types computer hardware (laptop or desktop computers etc.).

### Detailed Description of the Method

Below is a description of the various portions of one embodiment of the inventive method. The description is listed first in outline form, for clarity, and then each entry in the outline is described further.

### 1. Building up the pre-determined databases

### 2. User registration

2.1. Getting user's own metadata

2.2. User loading his/her images

2.3. User loading his/her own face photos

2.4. User determining security preferences

2.5. User loading his/her own voice data

2.6. User answering questionnaire to identify his/her own personality

2.7. Getting information about user expectations (search criteria)
2.7.1. User entering face photos that he/she likes or dislikes
   2.7.1.1. User loading the face photos
   2.7.1.2. User selecting face photos from a picture gallery
   2.7.1.3. User giving overall score to each face in the selected/loaded photos
   2.7.1.4. User giving partial scores to each part of each face in the selected/loaded photos
2.7.2. User inputting metadata search criteria
2.7.3 User answering the questionnaire to identify his/her favored personality
2.7.4. User entering voice data that he/she likes or dislikes
   2.7.4.1. User loading the voice data(s)
   2.7.4.2. User selecting voice data(s) from a voice gallery
   2.7.4.3. User giving overall score to each selected/loaded voice data
   2.7.4.4. User giving partial scores to each feature of each selected/loaded voice data

2.8. Analysis of the collected data
2.8.1. Analysis of the face photos
   2.8.1.1. Extracting facial features
      2.8.1.1.1. Anatomical features
      2.8.1.1.2. Human Vision System-based features
2.8.2. Analysis of the voice data
   2.8.2.1. Computing voice features
      2.8.2.1.1. Determination of invalid recordings,
      2.8.2.1.2. Voice analysis
         2.8.2.1.2.1. Articulation quality
         2.8.2.1.2.2 Speed of speech
         2.8.2.1.2.3. Fundamental frequency
         2.8.2.1.2.4. Relative audio periods
         2.8.2.1.2.5. Energy

2.9. Possible-match template construction
2.9.1. Possible-match face template construction
   2.9.1.1. Mapping user scores to each facial feature
   2.9.1.2. Synthesizing facial features and related user scores
2.9.2. Possible-match voice template construction
   2.9.2.1. Mapping user scores to each voice feature
   2.9.2.2. Synthesizing voice features and related user scores
2.9.3. Possible-match personality template construction
   2.9.3.1. Identifying personality features of the right match for the user
   2.9.3.2. Getting feedback from user

2.10. Database Registration

### 3. Database search for possible matches

3.1 Computing similarities

3.2. Presentation of the search results to the user

3.3 User selecting the persons he/she wants to meet.

3.4. Comparison of the user selection to the ranking of the system.

3.5. User providing feedback and adjusting the system

### 1. Building Up the Pre-Determined Databases

The system has predetermined face photos and voice data of celebrities, stars, football players and so on which are available in the public domain. The matchmaking system enables users to select face photos and/or voice data from such database to provide the search criteria inputs instead of, or in addition to, loading face photos and/or voice data of one or more favored/unfavored persons. The system may also have a pre-composed database of volunteers or paid people. The user may select persons from this database as well.

To build up or expand the predetermined/pre-composed databases, a system administrator enters the profile and frontal face photos and/or voice data of such persons into the system, and the system computes appropriate features and then records them to the appropriate portion of the database.

### 2. User Registration

To register on the matchmaking system, a user enters his/her own data, his/her security preferences, his/her search criteria as face photos, metadata, voice data, personality features. The system analyzes the data provided by the user to extract the necessary information (numerical representations) needed for matching and stores the extracted information to the database.

### 2.1 Getting a User's Own Metadata

At this step in the method, personal information (metadata) is collected about the user, such as the age, place of birth, gender, income, hobbies, education, speaking language, and etc. User's metadata can be entered by the following two ways: (1) the user loading his/her metadata or (2) transferring information about the user from the available CRM (customer relationship management) databases.

### 2.2 User Loading His/Her Images

The user may upload images of himself/herself as a photo album. Those images will help others to have an opinion about the overall appearance of the user. Images in this set are not processed by the system, but are only saved to the database.

### 2.3 User Loading His/Her Own Face Photos

The user uploads his/her own images to the system. The user may upload both old and current images through the use of webcam, camera or camera phone. At the moment an image is captured, the facial muscles should be still; it is preferable that the user not be laughing, grimacing, etc.

The photos are taken preferably from both the front and the profile. Photos taken at another angle may hinder the reliable analysis of the system. At the moment the photo is taken, the user should be looking straight ahead. All photos uploaded by the user may be checked by the system.

The photos may be sent by all digital formats, such as MMS or e-mail. To help the user take appropriate shots, a webcam connected to the computer and a computer program provided by the system may be used. The user may also upload a video of his/her face. Among the video frames, the system may select from among those that are the acceptable images for computing numerical representations.

### 2.4 User Determining Security Preferences

The user may select a membership status. Other options are related to a user's permissions about his/her visibility to other users. For example, the user may give permission to others to view his/her pictures and/or personal information. The user may choose to deal with only or primarily the matches of those who gave permission for others to view his/her images and/or personal information.

### 2.5 User Loading His/Her Own Voice Data

The user's voice is recorded by means of microphones, mobile phones or any other phone or voice-recording device connected to a computer. It is important that information about the recording be provided. The user may inform the system about the type of device and the type of the microphone used for recording the voice. During the voice recording, the user may form his/her own sentences and/or speak previously-determined text. The recorded voice data may be sent to the system by means of internet or mobile phone operators.

The recorded voice data is analyzed at the stage of analysis and the relevant analysis information (numerical representations of the voice data) is saved into the database.

### 2.6 User Answering Questionnaire to Identify His/Her Own Personality

The matchmaking system identifies personality features of the user by applying a psychological test as the questionnaire. Any of a number of available questionnaires may be used, such as “The Big Five Personality Test” readily available on the internet.

### 2.7 Getting Information About User Expectations (Search Criteria)

When the user selects or uploads information about a person that he/she is interested in, his\her interest will be evaluated. The user will be asked to give scores to the items of the available information in order to indicate how much he/she cares for or likes each feature of such a person. It may be noted that those scores do not pertain just to the positive but also to the negative opinions of the user about each feature.

### 2.7.1. User Entering Face Photos that He/She Likes or Dislikes

The user provides data about his/her favored/unfavored facial appearance in two ways: (1) loading their own favored face photos, or (2) selecting from images in the “pre-determined” data of the system database.

### 2.7.1.1. User Loading the Face Photos

If available, the user may load the images of favored persons (ex-lover, ex-spouse, celebrities and stars, etc.) into the system to represent the favorite facial features. The user is able to save photos of preferred persons with whom he/she had previously been romantically involved. The information computed by the system from these photos (numerical representations of the image data) is saved in the database and is associated with the user. Such information may also be provided by means of a questionnaire instead of images. The photos are taken preferably from both the front and the side (profile). Photos taken at an angle may hinder the reliable analysis of the system. The images should be of persons looking straight ahead for reliable analysis. All photos uploaded by the user are checked by the system. Photos may be sent by all digital formats like MMS or e-mail. For helping the user to take appropriate shots, a webcam connected to a computer and a computer program provided by the system may be used. The user may also upload a video of his/her favored/not favored face. Among the video frames, the system may select from those that are acceptable images.

### 2.7.1.2 User Selecting Face Photos from a Picture Gallery

This embodiment of the inventive matchmaking system includes a photo database of celebrities, stars, football players and so on (pre-determined database) based on photos in the public domain. The user can select the names of the celebrities he/she likes/dislikes from a list available in the system. The images of the celebrities found in the database are presented to the user along with questions regarding likes/dislikes.

The system may have a pre-composed database of volunteers or paid people. The user can select persons from the pre-composed database based on their facial images. This selection may begin from an initially-presented set and be guided by the system as it analyzes information/responses given by the user. The user may also enter text information about requirements of the possible match.

### 2.7.1.3. User Giving Overall Score to Each Face in the Selected/Loaded Photos

The user rates (for example, 1 to 10 with a 1 being the most disliked and a 10 the most liked) the face that he/she entered by either selecting from a pre-determined database or by loading it into the system by himself/herself. This rating indicates an overall score of how much he/she likes/dislikes the face. For example, giving a face a 1 rating means the user does not favor the face at all (using the rating scale example noted above).

### 2.7.1.4. User Giving Partial Scores to Each Part of Each Face in the Selected/Loaded Photos

In this step, the user rates (for example, 1 to 10 with a 1 being the most disliked and a 10 the most liked) each part of the face, such as eyes, nose, and lips. For example, the user may give an overall rating of 1 while giving a partial rating of a 10 to the eyes of a selected face image. Such a combination means that the user strongly dislikes the overall appearance of the face but likes the eyes very much. The user is looking for matches with facial features very dissimilar to those of the selected face but having eyes very similar to those of the selected face.

### 2.7.2.2 User Inputting Metadata Search Criteria

The user may enter metadata about the expected match, such as age, city, hobbies, eye color, skin color, education, income, speaking language, etc. The user may set the priorities for the personal preferences based on metadata of the candidate. These priorities may be represented as percentages (%). Priorities may also be set as a 0 or a 1 with 1 representing high importance and 0 representing a “don't care.”

### 2.7.3. User Answering the Questionnaire to Identify His/Her Favored Personality

The user may enters into the system the personality features of the favored persons with whom he/she previously had been romantically involved and which features are favored or not, such data being entered in the form of responses to a questionnaire. The system may also identify personality features of the favored person by applying a psychological test as a questionnaire.

### 2.7.4. User Entering Voice Data that He/She Likes or Dislikes

The user may provide data about his/her favored/not favored voice characteristics in two ways: (1) loading his/her own favored voice data, or (2) selecting voice data from the system database.

### 2.7.4.1. User Loading the Voice Data(s)

The voices of the persons favored by the user may be recorded for the purpose of analysis and to give the opportunity for the other candidates to listen to the voice. This process is carried with the same type of hardware by which other voice data may be captured, as noted above. In the case of the user loading such voice data, the system checks to see if such data is acceptable.

### 2.7.4.2. User Selecting Voice Data(s) from a Voice Gallery

The matchmaking system includes is a database with voices of the celebrities, stars, etc. The user is asked to indicate the kind of voice he/she favors. Also, the user is enabled to listen to sample voice data and is requested to select the favored voice type from a large selection of voice types.

### 2.7.4.3. User Giving Overall Score to Each Selected/Loaded Voice Data

The user rates (for example, 1 to 10 with a 1 being the most disliked and a 10 the most liked) the voice data that he/she entered by either selecting from a pre-determined database or by loading the voice data into the system by himself/herself. This rating indicates an overall score of how much he/she likes/dislikes a voice. For example, giving a voice a rating of 10 means that the user has decided that the voice is highly desirable.

### 2.7.4.4. User Giving Partial Scores to Each Feature of Each Selected/Loaded Voice Data

In this step, the user rates (for example, 1 to 10 with a 1 being the most disliked and a 10 the most liked) each feature of select/loaded voice data, rating features such as speed, accent, and tone. For example, the user may give an overall rating of 9 while giving a partial rating of 5 to the speed of the selected/loaded voice data. Such a combination of ratings means that the user prefers a match having largely the same voice features as the selected/loaded voice except that the speed of the voice of the match may be different.

### 2.8 Analysis of the Collected Data

### 2.8.1 Analysis of the Face Photos

At this step in the inventive matchmaking method, the images of the user are analyzed for use in the subsequent searches by other users. In addition, the face photos of the persons favored/not favored by the user are analyzed to construct a possible face template. The system uses facial images to extract numerical representations of anatomical facial features and human vision system (HVS)-based features. To compare faces in the matching process, only anatomical and HVS-based features will be used, not the face images themselves.

### 2.8.1.1. Extracting Facial Features

Two sets of facial features are computed. A first set of features, anatomical features, is extracted using both frontal and profile face images. A second set, called human vision system features, is extracted only from frontal face images. When either only a frontal or profile image exists, only the appropriate feature set will be extracted, and matching may be done using only that set of features. The details related to freckles, dimples, face shape, skin color and cheekbone are also be obtained from the images.

### 2.8.1.1.1. Anatomical Features

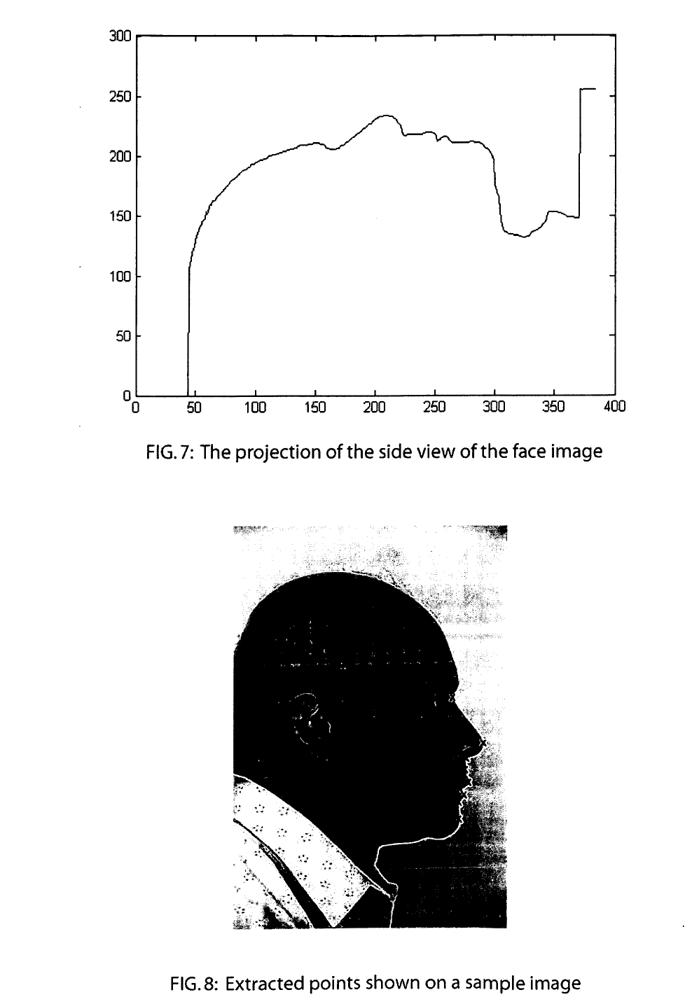

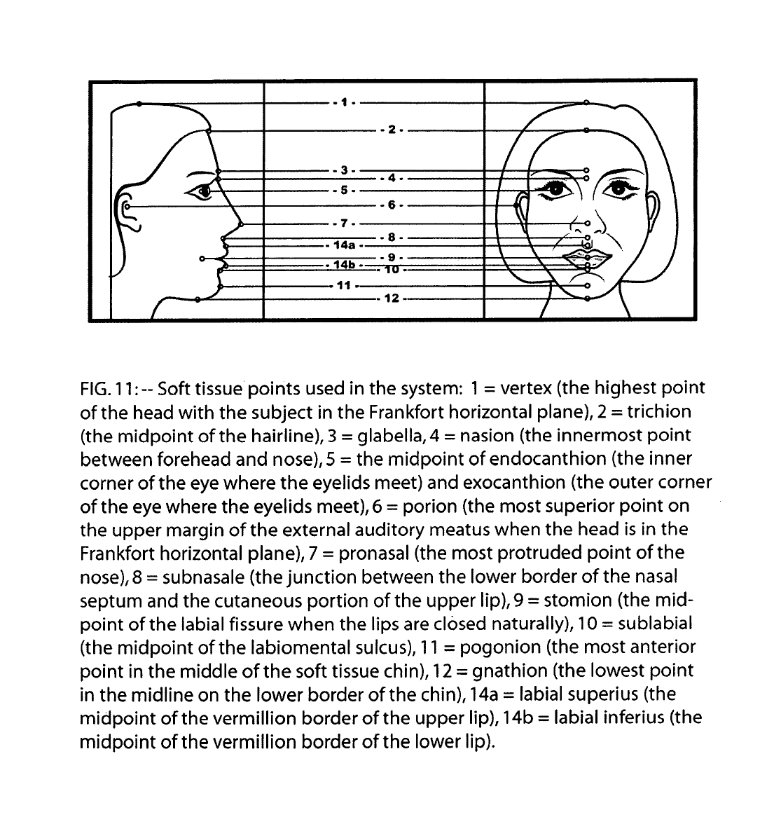

To extract anatomical features, anatomical feature measuring points are determined for the user, and various proportions and measurements are formed in relation to the person's face. FIGS. 7-8 and 11-23 illustrate numerous anatomical measures including several plastic-surgery-unique anthropometric facial measures. FIG. 7 shows a projection of the profile image of FIG. 8. FIG. 11 shows schematic exemplary frontal and profile images illustrating soft tissue points which plastic surgeons typically identify as means to establish the measures, both those unique to their field as well as some more common measures. As a result of such analysis, at least some or all of the following proportions and measurements are recorded into the database as the numerical values related to the facial images.

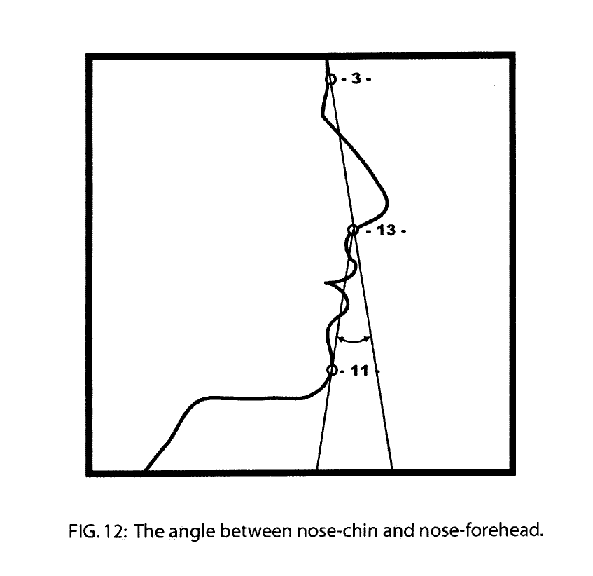

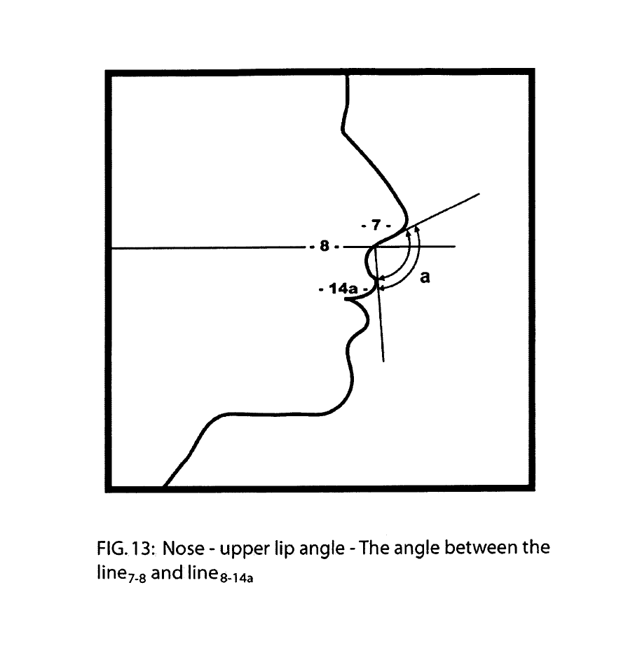

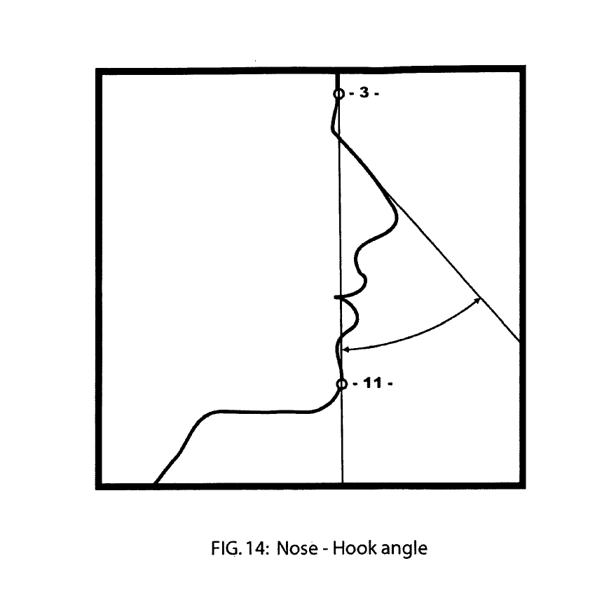

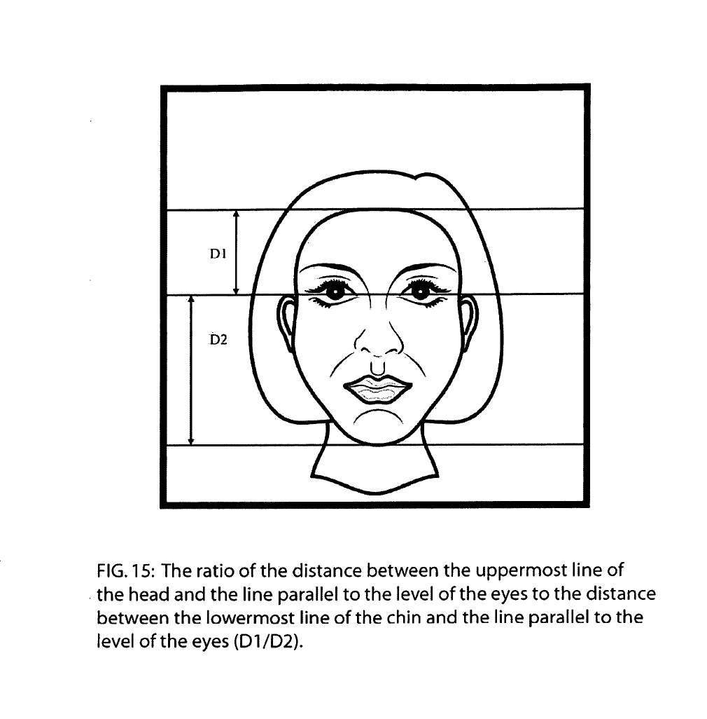

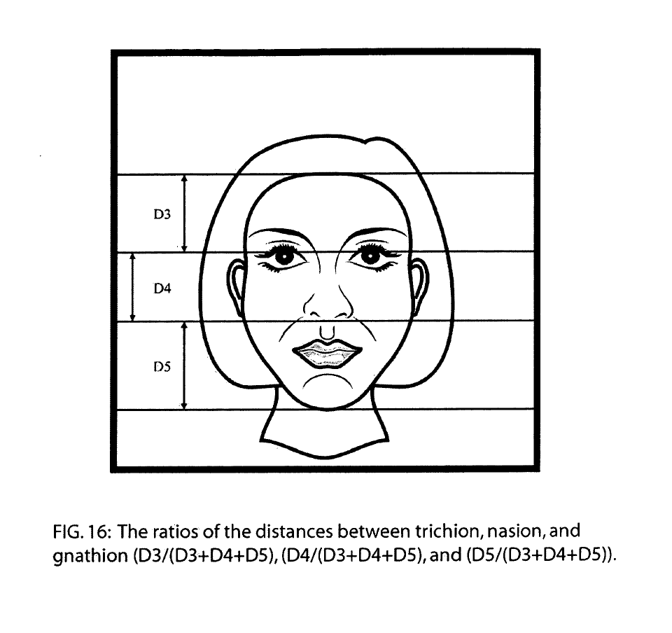

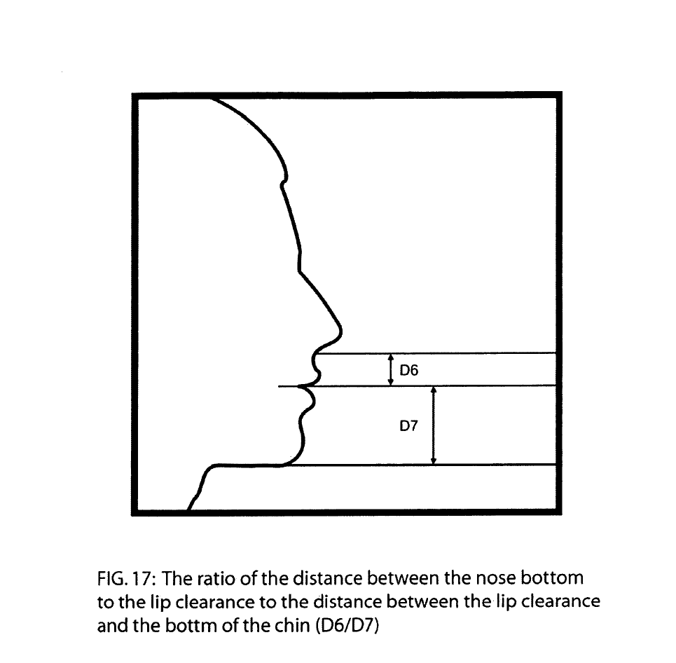

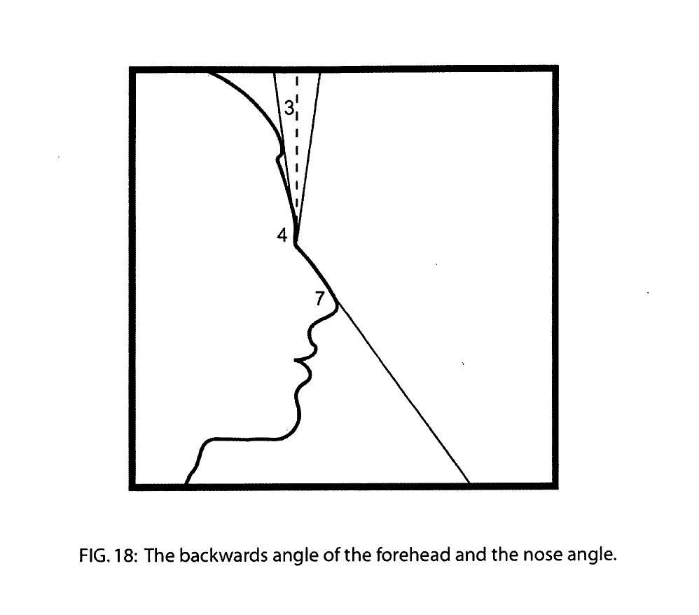

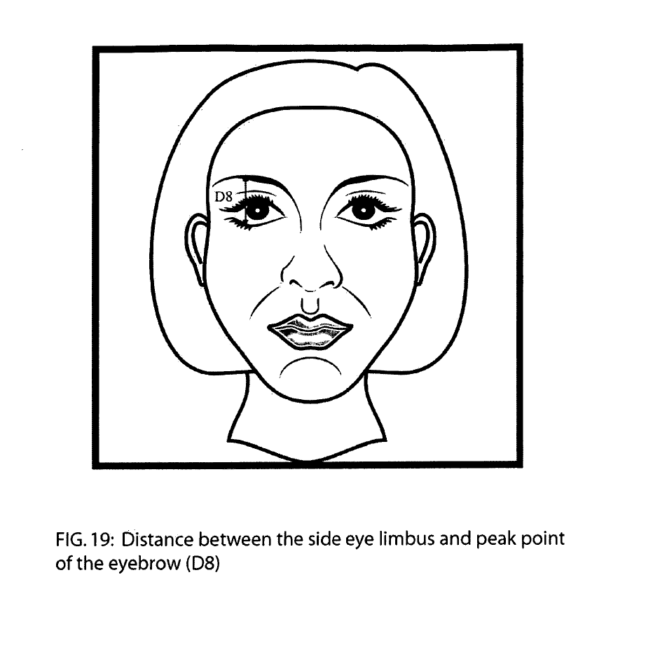

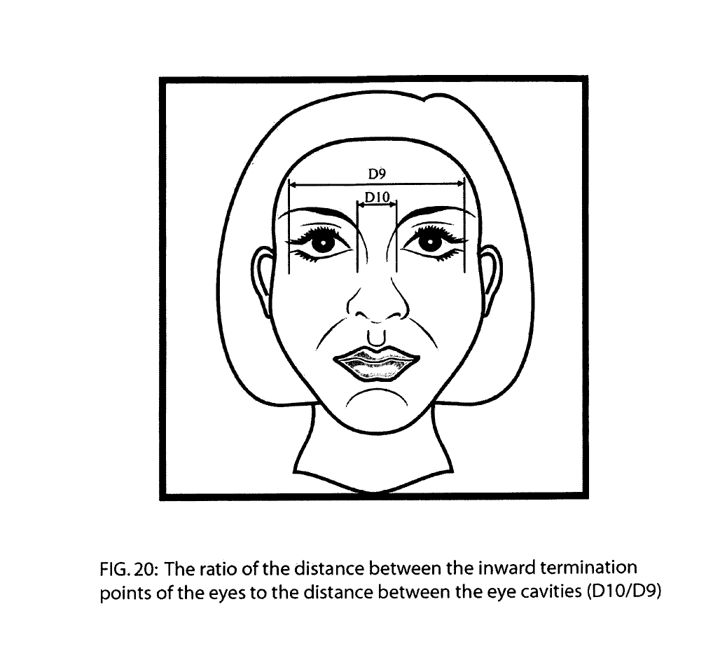

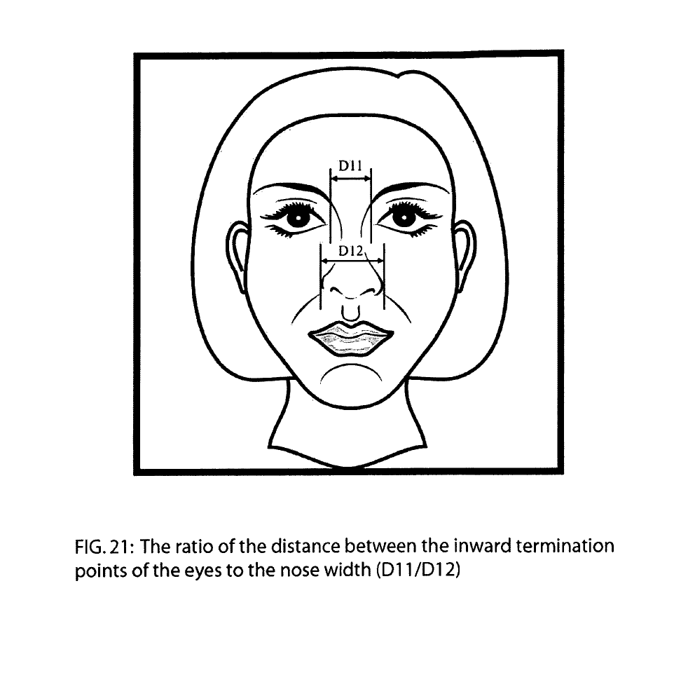

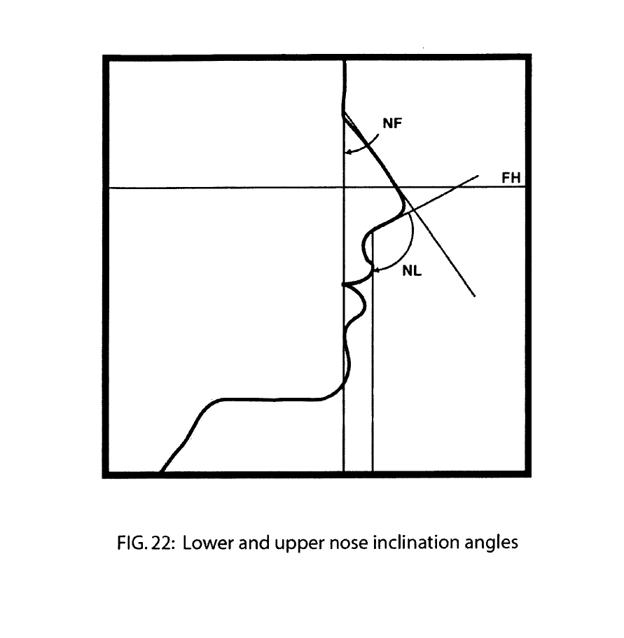

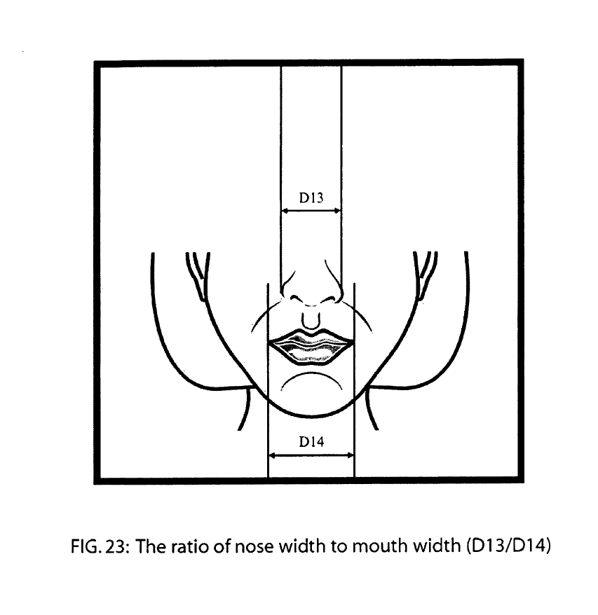

FIGS. 12-23 illustrate several of these measures in detail, as noted below. Those which are plastic-surgery-unique anthropometric features are so indicated below with an asterisk (*).
Nose-chin angle between the nose and the forehead (FIG. 12)*
Nose-upper lip angle (FIG. 13)*
Nose hook angle (FIG. 14)*
The ratio of the distance between the uppermost line of the head and the line parallel to the level of the eyes to the distance between the lowermost line of the chin and the line parallel to the level of the eyes (FIG. 15)
The ratio of the distances between trichion, nasion, subnasale and gnathion (FIG. 16)
The ratio of the distance between the nose bottom and the lip clearance to the distance between the lip clearance and the bottom of the chin (FIG. 17)
The backwards angle of the forehead and the nose angle (FIG. 18)*
The distance between the side eye limbus and the peak point of the eyebrow (FIG. 19)*
The ratio of the distance between the inward termination points of the eyes to the distance between the eye cavities (FIG. 20)*
The ratio of the distance between the inward termination points of the eyes to the distance of the nose width (FIG. 21)*
Lower and upper nose inclination angles (FIG. 22)*
The ratio of the nose width size to the mouth width size (FIG. 23)

In this method, the projection of the side view of the face image is taken as shown in FIG. 7. The profile, denoted as p(x), x being the horizontal direction, is filtered by a low-pass filter to eliminate the noise. The peak is of p(x) is obtained and denoted as the tip of the nose, i.e., x₁ showing the position of the tip of the nose in the horizontal direction. In order to find the points 3-12 given in FIG. 11, the local minima and maxima of p(x) are found for 0-x₁ and x₁-xₙ, xₙ being the lowest point of the face. Selected points found using this method on a sample image is shown in FIG. 8.

### 2.8.1.1.2. Human Vision System-Based Features

To extract HVS-based features, feature vectors are extracted at points on the face image with high information content. Filtering based on Gabor kernels is utilized to extract feature points. The use of Gabor kernels and the mathematics associated with such filters is well-known to those skilled in the art of face recognition.

In most feature-based face-matching methods, facial features are thought to be, for example, the eyes, nose and mouth or, as in graph-matching algorithms, vectors are extracted at nodes of a graph which are the same for every face image. Such locations are herein referred to as standard locations. However, in this inventive method, locations and the number of feature points are not fixed, so the number of feature vectors and their locations can vary in order to represent different facial characteristics of different human faces. In this way, feature points are not only located around the main facial features (eyes, nose and mouth) but also around the special facial features of an individual, such as dimples. Selection of feature points is done automatically by examining the peaks of filter responses. Thus, significant facial features can be found at non-standard locations as well as standard locations of the face.

Since feature points are common to different spatial frequencies, this method is insensitive to scale changes. Moreover, if the feature comparison is done by shifting elements of feature vectors composed of Gabor kernel coefficients with different orientations, this method would also be insensitive to orientation changes.

Determination of the Feature Point Locations

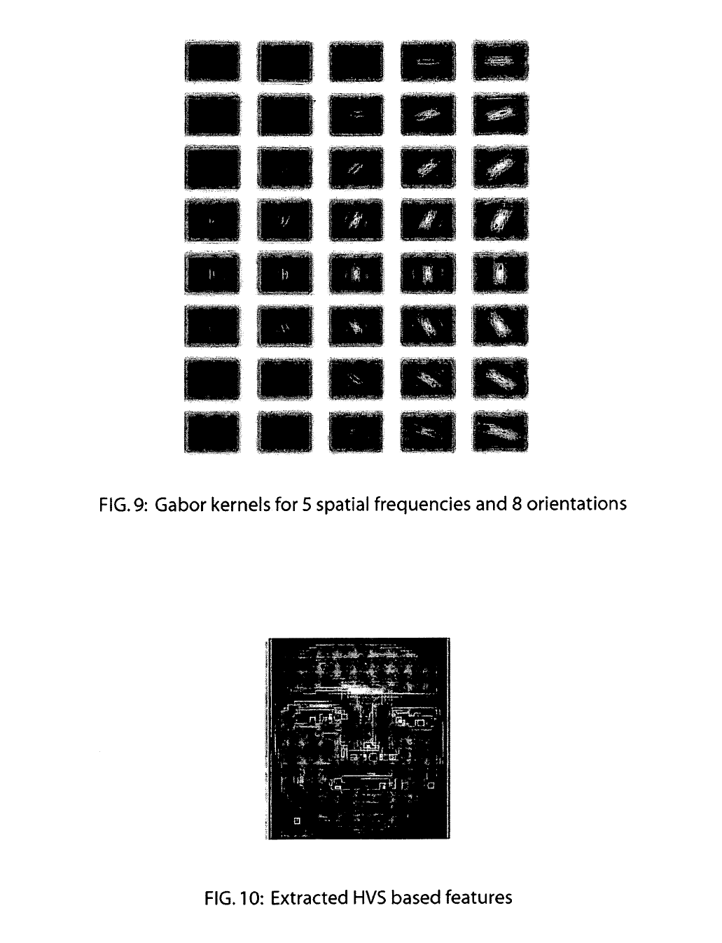

Face image I is filtered by 40 Gabor kernels, GK, with five different spatial frequencies and eight different orientations. FIG. 9 illustrates such a set of Gabor kernels.

R_{i,j}=GK_{i,j} [symbol] I

where R_{i,j} is a set of 40 images of the same size as image I generated by a convolution the image I with GK_{i,j}. Feature points are found as the local maxima within the R_{i,j} images, such maxima found to be common to all spatial frequencies at each orientation. The maxima are found in a w×w window, for example, a 9×9 pixel window. Window size w×w may be small enough to capture the important features and large enough to avoid redundancy. Exemplary extracted features are shown in FIG. 10.

Extracting Feature Vectors

Feature vectors are extracted by sampling responses at feature points to Gabor kernels with five different spatial frequency and eight different orientations. Therefore, feature vectors are composed of 40 elements. Since the feature point locations are not fixed, the locations of feature vectors are also stored. The location of the i^{th} HSV feature vector is: HVS_cᵢ={xᵢ,yᵢ}

i^{th} HVS feature vector: HVS_vᵢ(k,l)={R_{k,l}(xᵢ,y,)}
l=1, . . . , 8
k=1, . . . , 5
i=0, . . . Number of feature points
where (xᵢ,yᵢ) are the Cartesian coordinates of the feature point, R_{k,l} is the response to the Gabor kernel at k^{th} spatial frequency and l^{th} orientation.

### 2.8.2. Analysis of the Voice Data

Voice data is saved in .wav or a similar format. The system obtains information on education levels, family features, regional characteristics and style of speech derived from a given person's audio samples and analysis of audio samples determines styles of speech.

### 2.8.2.1. Computing Voice Features

Computation of voice features includes determining numerical attributes from audio data gathered and interpretation of the numerical attributes. When a user is reading out sentences, it is useful for the reader to practice such sentences before recording.

The variables which may be determined as numerical representations of voice include, but are not limited to: the differences and activity of formant attributes; mel-frequency capstral coefficients (MFCCs) such as skewness, kurtosis, standard deviation; words per minute and phomeme and syllable speed; fundamental frequency mean, range and contour; rate of comparative phonemes; and mean, range, and minima and maxima of acoustic energy.

The speech processing techniques and approaches to measurement are well-known to those skilled in the art of speech processing. This invention is based in part on the discovery that numerical representations of voice, as opposed to mere subjective listening, greatly enhances the capabilities of computerized matchmaking.

### 2.8.2.1.1. Determination of Invalid Recordings,

The system guides the user during recording. Analysis of noise level rejects recordings with high noise. When a user reads a predetermined text, the system also checks for correctness. Recordings may also be listened to and edited by an experienced person so that faulty, loud and frivolous recordings may be eliminated.

### 2.8.2.1.2.1. Articulation Quality

Articulation relates to brain control of speech which effects the transition or continuity of a single sound or between multiple sounds. The time-varying attributes of the signal will increase or decrease depending on how fast the articulators act. In the inventive matchmaking system, the difference between and activity of formant attributes (peaks in an acoustic frequency spectrum which result from the resonant frequencies of any acoustic system) are measured in the voice data of a user. The differences in formant dynamics (such as formant frequencies, bandwidth, peak values, etc.), the time-varying magnitudes of these attributes, and the change of the spectral envelope are evaluated. The distribution of harmonic and noise parts of speech content are also used as articulation attributes.

Mel-frequency cepstral coefficient (MFCC) analysis is also used, along with related statistical distribution properties (e.g., skewness, kurtosis, standard deviation, etc.) to classify similar voices. MFCC analysis takes into account acoustic-phonetic attributes. The matchmaking system uses MFCC parameters both on the frame level (segmented speech) and on the utterance level (whole speech signal). The system models the distribution of the MFCC parameters on the frame level in order to obtain a more detailed description of the speech signal. Standard MFCC parameters are extracted and then dynamic spectral features known as delta and delta-delta features (the first and second derivatives of the MFCC coefficients) are added, resulting in a higher-dimensional vector. Delta MFCC measures are also used on the utterance level.

### 2.8.2.1.2.2. Speed of Speech

Speed of speech is measured as words per minute. The matchmaking system segments each word in a recorded voice and counts the segments. Phomeme and syllable speed is also determined, by phonetic segmentation and dividing into syllables in order to fully interpret the speed of speech.

### 2.8.2.1.2.3. Fundamental Frequency

Fundamental frequency (F0) is the dominating frequency of the sound produced by vocal cords. The fundamental frequency is the strongest indicator of how a listener perceives the speaker's intonation and stress.

F0 is visible only at points at which speech is voiced, i.e. only at times when the vocal cords vibrate. Although the spectrum of a speech signal can cover a range between 50 Hz and 10 k Hz, the typical F0 range for a male is 80 to 200 Hz, and for a female, 150 to 400 Hz. The matchmaking system captures the fundamental frequency of a recorded voice by analyzing the voice with pitch analysis. Mean F0 and F0 range are extracted and the melodic characteristics of the voice data are analyzed by the variance of pitch. Speech prosody is analyzed using the pitch contour. When the voice data is related to predetermined text, the comparison of the patterns of F0 on words is evaluated.

### 2.8.2.1.2.4. Relative Audio Periods

This feature of speech is used in performing text-dependent comparison. After compensating for the nonuniform effects that the speed of speech has on phonemes, the rate of comparative phonemes is measured.

### 2.8.2.1.2.5. Energy

The matchmaking system determines the energy distribution of voice data, and the energy distribution is used both for pre-processing (such as noise reduction and silence detection) to increase the accuracy of other feature extraction processing and as an acoustical variable to compute statistics of the voice data, such as mean energy, energy range, and minima and maxima energy, all of which are useful for voice comparison.

### 2.9 Possible-Match Template Construction

During data analysis, the system finds the available features from each class of data and then constructs possible-match templates to synthesize each class of data to create a model for matching.

### 2.9.1. Possible-Match Face Template Construction

### 2.9.1.1. Mapping User Scores to Each Facial Feature

Extracted facial features are low-level data, and the scores or ratings assigned to the facial parts are associated with those features. For example, a partial score assigned to the eyes relates to both the spacing and the depth of eyes.

### 2.9.2. Synthesizing Facial Features and Related User Scores

As the first step, features common to every favored person of the user are inspected and an additional score is determined indicating the appearance frequency of each feature. A weight (“significance score”) for each feature is computed by combining the overall and partial scores entered by the user.

As the second step, favored persons' features are synthesized to form a model. For the anatomical features, mean and standard deviation values for each feature are computed.

$${Model}_{i} \text{:} {Anatomical\_v}_{j} \text{:} value = {mean}_{k} [ {FavoredFace}_{k} \text{:} {Anatomical\_v}_{j} \text{:} value ]$$

$${Model}_{i} \text{:} {Anatomical\_v}_{j} \text{:} std = {std}_{k} [ {FavoredFace}_{k} \text{:} {Anatomical\_v}_{j} \text{:} value ]$$

and

if (Modelᵢ:Anatomical_vⱼ:std=0) [symbol] Modelᵢ:Anatomical_vⱼ:std=th_{std}

j=0, . . . , Number of anatomical features
k=0, . . . , Number of favored faces
where FavoredFaceᵢ:Anatomical_vⱼ:value=measured value, Modelᵢ is the possible-match face model of the i^{th} user, and th_{std} is the default value of the system. A typical value for th_{std} is about 0.1.

For HVS-based features, a pool of feature vectors belonging to the favored faces of the user is formed. Then similarities between each pair of vectors are inspected.

To find whether two feature vectors are similar enough, the following two criteria are examined at different spatial frequency combinations. (1) The distance between their coordinates is examined, and if the distance <th₁, where th₁ is the approximate radius of eyes, mouth and nose, then a possible feature location is noted. Comparing the distances between the coordinates of the feature points avoids the matching of a feature point located around the eye with a point that is located around the mouth. A typical value for th₁ is on the order of six pixels. (2) The similarity of two feature vectors is examined, and if the similarity >th₂, where th₂ is the similarity threshold, then a feature location has been identified. A typical value for th₂ may be about 0.9.

Similarity Function

To measure the similarity of two complex valued feature vectors, the following similarity function is used:

$${S}_{1 , 2} ( k , j ) = \frac{\sum [ {v}_{1} ( k , l ) \cdot {v}_{2} ( j , l ) ]}{\sqrt{\sum {{v}_{1} ( k , l )}^{2} \times \sum {{v}_{2} ( j , l )}^{2}}}$$

S_{1,2}(k,j) represents the similarity of two feature vectors, v₁ and v₂, at k^{th} and j^{th} spatial frequencies of the feature vectors v₁ and v₂ respectively, and l is the orientation index. The numerator of the right side of the equation represents a dot product or an inner product of the two vectors, indicated by the “▪” operator.

Then, feature vectors that are similar enough to each other are grouped to form a “match set.” Since each vector at least will match itself, each set will have at least one element, and every feature vector in the pool will be placed in a match set.

$${Model}_{i} \text{:} {HVS\_v}_{n} = {median}_{p} ( {MatchSet}_{n} \text{:} {v}_{p} )$$

n=1, . . . Number of match sets
p=1, . . . , Number of feature vectors in the current match set
where Modelᵢ is the possible-match face template of the i^{th} user.

In summary, the possible-match facial features are composed of two sets of features, namely, anatomical features with two components (values and weights, the weight being significance scores), and HVS-based features with two components, feature vector values and weights (significance scores).

### 2.9.2. Possible-Match Voice Template Construction

### 2.9.2.1. Mapping User Scores to Each Voice Feature

As the first step, features common to every favored person of the user are inspected and an additional score is determined indicating the appearance frequency of each feature. A weight (“significance score”) for each feature is computed by combining the overall and partial scores entered by the user.

### 2.9.2.2. Synthesizing Voice Features and Related User Scores

As the second step, favored persons' voice features are synthesized to form a model. Mean and standard deviation values for each feature are computed.

### 2.9.3. Possible-Match Personality Template Construction

### 2.9.3.1. Identifying Personality Features of the Right Match for the User

The system identifies the personality features of the right match for that user by considering the user's personality features. That is, the system makes this determination based on the personality of the user, not based on the preferences of the user. This step is independent of expected personality features entered by the user; in other words, the system decides what is best for the user.

### 2.9.3.2. Getting Feedback from User

The system presents proposed personality features for a final user decision. In this step, the user may select the personality features that he/she finds attractive although the system indicates that the possibility of a good relationship is low between the user and such a person.

2.10 Database Registration

After analyzing the data provided by the user, the system stores extracted information to the database. The following information is stored for each user:
own data
facial features
voice features
metadata
security preferences
own personality features
possible-match template data
possible-match metadata
possible-match facial features (values and weights)
possible-match voice features possible-match personality features

### 3. Database Search for Possible Matches

In this stage, the user enters a weight for each data class (face, voice, metadata, personality) to guide the matching process. These weights are estimates by the user of how important each class of data is to the user.

To find a match for a user, similarities between the data of his/her possible-match template and the data of other users is compared. This comparison begins separately on each data type and is combined to reach a final result.

### 3.1 Computing Similarities

To find a match, similarities are computed based on facial features, voice features, metadata, and personality features.

To compare anatomical features, the differences of each vector value are computed as the distance and if the distance is below the maximum allowed deviation it is determined to be a matching feature. Then, for each matching feature, that feature's significance score is divided by its distance, and the mean of those values is assigned as the matching score of the possible-match face template of the anatomical features and the probe user.

Similarities between the possible-match face template of the HVS based features, and the HVS based features of each user in the system database are computed as follows:

By computing vector similarities, similarity between the n^{th} possible-match face template feature of the i^{th} user and the p^{th} feature of the m^{th} database face (probe face) is computed as follows:

$${Face}_{m} : {S}_{p , n} ( k , j ) = \frac{\sum [ {Model}_{i} : {HVS\_v}_{n} ( k , l ) \cdot {Face}_{m} \text{:} {HVS\_v}_{p} ( j , l ) ]}{\sqrt{\sum {Model}_{i} \text{:} {HVS\_v}_{n} {( k , l )}^{2} \times \sum {Face}_{m} \text{:} {HVS\_v}_{p} {( j , l )}^{2}}}$$

if

|Modelᵢ:HVS_{—}cₖ−Faceₘ:HVS_{—}cₚ|<th₁

and

$$\frac{\sum [ {Model}_{i} \text{:} {HVS\_v}_{n} ( k , l ) \cdot {Face}_{m} \text{:} {HVS\_v}_{p} ( j , l ) ]}{\sqrt{\sum {Model}_{i} \text{:} {HVS\_v}_{n} {( k , l )}^{2} \times \sum {Face}_{m} \text{:} {HVS\_v}_{p} {( j , l )}^{2}}} > {th}_{2}$$

l=1, . . . , 8
else

### Faceₘ:S_{p,n}(k,j) is set to 0.

### Then by examining the vector similarities, only one matching feature vector of the m^{th} database face, which has maximum similarity, is assigned as a match to the n^{th} possible-match face template feature.

$${Face}_{m} \text{:} {Sim}_{n} ( k , j ) = {max}_{1 \leq p \leq {N}_{m}} ( {Face}_{m} \text{:} {S}_{p , n} ( k , j ) )$$

where Nₘ is the number of feature vectors of the m^{th} database face.

### Faceₘ:Simₙ is the similarity of the best match over all of the features of the m^{th} database face to the n^{th} feature of the possible-match template.

$${Face}_{m} \text{:} Average ( k , j ) = \frac{{\sum }_{n = 0}^{{N}_{p}} {Face}_{m} \text{:} {Sim}_{n} ( k , j )}{{N}_{m - 0}}$$

$${N}_{m - 0} = {{\sum }_{n = 0}}^{{N}_{p}} ( {Face}_{m} \text{:} {Sim}_{n} ( k , j ) )$$

where Nₚ is the number of features of the possible-match face template.
Faceₘ:Average(k,j) represents the average similarity of possible-match facial features at the k^{th} spatial frequency to the m^{th} database face features at the j^{th} spatial frequency, where Nₘ is the number of feature points of the probe face and Nₘ₋₀ is the number of feature vectors having nonzero similarity.

To find the matching face instead of comparing only average similarities, the number of vectors involved in the computation of the average similarity and the number of maximum similar vectors of each database (probe) face are taken into account through a matching rate:

MRₘ=(Nₘ₋₀/Nₘ)

The overall similarity of the possible-match face template at k^{th} spatial frequency to m^{th} database face face at j^{th} spatial frequency is computed as a weighted sum of the average similarity and the matching rate. Then,

Faceₘ:HVS_OS(k,j)=αFaceₘ:Average(k,j)+βMRₘ

where α and β are weighting factors. Typical values for α and β are 0.6 and 0.4, respectively.

### As the last step, a final similarity between the m^{th} database face and the possible-match face template Faceₘ:HVS_Similarity is computed as the maximum similarity value over all the spatial frequency pairs (k,j).

$${Face}_{m} \text{:} HVS\_Similarity = {max}_{k , j} \{ {Face}_{m} \text{:} HVS\_OS ( k , j ) \}$$

### The spatial frequency combination that yields the maximum similarity may also be found using an appropriate search algorithm.

Measurements and proportions of the feature points are different for different races. In such cases, the races of the users are noted in advance and the ranges in a proportion and measurement table are expanded or reduced based on the information obtained. In this way, the ideal measurement-proportion ranges are obtained for different races. Preferably, measurement-proportion ranges for eyes, nose, lips and cheeks and chin are inspected.

Based on Voice Features

Comparing voice features is similar to comparing anatomical features. The differences of vector values are computed as the distance and, if the distance is below the maximum allowed deviation, it is determined to be a matching feature. Then, for each matching feature that feature's significance score will be divided by its distance and the mean of those values is assigned as the matching score of the possible-match voice template and the probe user.

Based on Metadata

In the simplest case of this determination of similarity, a 0-1 comparison is used. If two items are identical to the metadata of the user's possible match and another user's metadata, the similarity result of that item will be a 1, otherwise, a 0. Also, for each item, an intelligent comparison can also be done to find a similarity by training the system. For example, the system can decide to match users from two cities that are not the same but only some miles away from each other, or, if one of the users likes to travel frequently, then the matching result of each item will be a similarity score between 0 and 1.

The matching result of each item is also be multiplied by its score entered by the user. The mean of matching results of the items will be assigned as the matching score of those two metadata. Then the matching scores of the metadata of the users in the system database will be ranked.

Based on Personality Features

Personality similarity is computed as the ratio of matching personality features of the possible-match personality template of the user to the probe's personality features.

Overall Matching Ratio

An overall matching ratio is computed as the weighted sum of the similarities computed for each data class (face, voice, metadata, personality) based on the user-entered weights showing which kind of data match is more important for the user. Moreover, the user can enter different weights for different features for each data class to indicate the importance of those feature. For example, if the user mainly attracted by the eyes of a person, he/she can enter a high weight to eyes, and the system would give priority to the matching of the eyes between the possible-match template of that user and that of a candidate.

System Also Computes Following Three Matching Ratios

The system presents matching results by evaluating using three ratios. The first ratio is the ratio between a user's (searcher) possible-match template data and matching user (probe) data which is the similarity measure of how much the probe matches the searcher. The second ratio is the ratio between the matching user's (probe) possible-match template data and the user's (searcher) data, which is the similarity measure of how much the searcher matches the probe. The third ratio, the “mutual match ratio,” is the average of the first two ratios and is a measure of how much the searcher and the probe match each other.

### 3.2. Presentation of the Search Results to the User

Among the individual of the universe satisfying the user's criteria, those who favor the user the most will be given priority in presentation. Among the individuals of the universe satisfying the user's criteria, those who also exhibit the best match for the aesthetic and anatomical features are given priority in presentation. (For example, the nose of a person may exactly match the user's criteria, but his/her chin may be much longer as compared to the anatomical proportions. Such a person will be listed toward the end of the search results.)

At the end of the process, the user is presented a list of the subscriber numbers of one or more candidate matches with mutual match ratios as well as the photos and the voices of those candidates (of the ones already permitted).

The user may modify his/her acceptable mutual match ratio in percentage by using an adjustable bar on the display (i.e. reducing the acceptable level to certain percentage).

### 3.3 User Selecting the Persons He/She Wants to Meet.

The user will tick the check boxes next to the candidates in the list presented to express his/her wish to meet the candidate(s). Based on the selection of the user, the match ratio with respect to the user will be sent to the candidates, and they will be asked whether they wish to meet the user. If a candidate also confirms, the user's information is first sent to the candidate; then, if the candidate accepts, the information of the candidate will be sent to the user.

### 3.4 Comparison of the User Selection to the Ranking of the System.

As the system is used, it will collect information about the types of selections the user has made among the presented alternatives. The system has adaptive features which enhance its matchmaking performance. If the user does not select the persons presented with priority, the system assesses this situation and improves itself based on the assessment of the user of the candidates suggested by the system.

### 3.5 User Providing Feedback and Adjusting the System

As mentioned in item 3.2 above, the system presents the search results considering priorities based both on the candidates who favor the user the most and on the best match for the aesthetic and anatomical features. Moreover, the overall matching ratio is computed as the weighted sum of the similarities computed for each data class (face, voice, metadata, personality). Therefore, by tracking and analyzing the user's responses with respect to candidate matches, the system updates and personalizes the priority-setting rules based on the common features of the user's prior selections.

Customer feedback starts with the determination of member preferences. Search results are presented to the users according to a certain order. To determine this order, the system uses many different criteria in sorting the results. The sorting is performed in such a way that the first result will be the person favored most by the user. However, the user may not base his/her preference on this ranking; and, if the user does not select the person(s) at the top of the list, it becomes evident that the user probably does not understand or evaluate his/her own preferences well or that these preferences evolved since the time of entry.

When the system presents the best matches, the user is asked to select/rate the preferred ones. Based on the images selected by the user, the accuracy of the analysis in the previous stage is determined. In case the user does not favor the face alternatives presented, the possible-match data of the user is updated and the search is repeated.

The system may receive user feedback in two ways. One way is that the user can select which candidates are acceptable/appropriate, and which are not; in other words, the user rates rates the candidates either by a 0 or a 1. Alternatively, the user can rate the candidates on a continuous scale. For example if user assigns a candidate a rating of anything from 0 to 1,with 0 meaning the user strongly dislikes the candidate, 0.5 meaning the user is hesitant about the candidate, and 1 meaning the that user finds the candidate to be a highly-desirable match, and so on. Then a user feedback ratio computed as follows:

$$UFR = \frac{{\sum }_{i = 0}^{N} rate ( i )}{N}$$

where N is the number of candidates rated by the user. If UFR<T_{UFR}, then the possible-match template of the user is updated by using the data of such preferred candidates and the associated ratings given by the user (see above paragraph) as new inputs to the possible-match template construction process, a process intended to identify additional preferred candidates for the user. T_{UFR} is the user feedback ratio threshold to update the possible-match template. A typical value for T_{UFR} is about 0.8.

As an alternative to the above feedback model, the user may also rate the parts or features of each data class (such as eyes of the face or speed of the voice, etc.). Thus, a user feedback ratio is computed separately for each feature as follows:

$${UFR}_{k} ( j ) = \frac{{\sum }_{i = 0}^{N} {rate}_{k} ( i , j )}{N}$$

where k is the class of the data (face, voice, etc.) and j is the feature/part of the data; for example (k,j)=(face,eyes). In other words, the system applies T_{UFR} to each feature/part of the related template.

If UFRₖ(j)<T_{UFR}(k,j), then only the (k,j) pair of the possible-match template is updated. T_{UFR}(k,j) can be uniform for each k and j, or different for each k.

While the principles of this invention have been described in connection with specific embodiments, it should be understood clearly that these descriptions are made only by way of example and are not intended to limit the scope of the invention.

1. In a matchmaking method of matching a user with one or more individuals of a universe of individuals in a matchmaking system utilizing data in a database, such data being associated with the user and with the individuals of the universe and including at least metadata and personality data, the improvement comprising the steps of:
obtaining recorded voice data and facial-image data for the user and for the individuals of the universe;
computing numerical representations of voice and facial features of the user and of the individuals of the universe and storing them in the database;
obtaining preference-data sets for the user and for the individuals of the universe;
computing numerical representations of the voice and facial features of the preference-data sets;
searching the database for at least one match between the numerical representations associated with the individuals of the universe and those associated with the preference-data set of the user,
whereby one or more individuals of the universe are selected as matches for the user.

2. The matchmaking method of claim 1 wherein the computing of numerical representations of voice features includes computing at least one of: (a) articulation quality measures; (b) speed of speech measures; (c) audio energy measures; (d) fundamental frequency measures; and (e) relative audio periods.

3. The matchmaking method of claim 1 wherein the obtaining of the preference-data set of the user includes the user's providing data on the degree the user likes the sample voices.

4. The matchmaking method of claim 1 wherein the computing of numerical representations of facial features includes measuring a plurality of anatomical features.

5. The matchmaking method of claim 4 wherein the plurality of anatomical features includes a plurality of plastic-surgery-unique anthropometric facial measures.

6. The matchmaking method of claim 5 wherein the plastic-surgery-unique anthropometric facial measures are selected from among:
the angle between nose-chin and nose-forehead;
nose-upper lip angle;
nose-hook angle;
the backwards angle of the forehead and the nose angle;
the distance between the side eye limbus and the peak point of the eyebrow;
the ratio of the distance between the inward termination points of the eyes to the distance between the eye cavities;
the ratio of the distance between the inward termination points of the eyes to the distance of the nose width; and
the lower and upper nose inclination angles.

7. The matchmaking method of claim 6 wherein the computing of numerical representations of facial features includes using Gabor kernels to locate features at both standard and non-standard facial points, such features having local maxima in the Gabor filter images.

8. The matchmaking method of claim 1 wherein the computing of numerical representations of facial features includes using Gabor kernels to locate features at both standard and non-standard facial points, such features having local maxima in the Gabor-filter images.

9. The matchmaking method of claim 1 wherein the searching identifies more than one match and the method further includes the additional steps of:
prioritizing the selected matches and presenting such prioritized matches to the user;
capturing user feedback regarding the prioritized matches; and
adjusting the numerical representation of the preference-data set of the user,
whereby the system improves its ability to identify matches satisfying the user.

10. The matchmaking method of claim 9 wherein the computing of numerical representations of voice features includes computing at least one of: (a) articulation quality measures; (b) speed of speech measures; (c) audio energy measures; (d) fundamental frequency measures; and (e) relative audio periods.

11. The matchmaking method of claim 9 wherein the obtaining of the preference-data set of the user includes the user's providing data on the degree the user likes the sample voices.

12. The matchmaking method of claim 9 wherein the computing of numerical representations of facial features includes measuring a plurality of anatomical features.

13. The matchmaking method of claim 12 wherein the plurality of anatomical features includes a plurality of plastic-surgery-unique anthropometric facial measures.

14. The matchmaking method of claim 13 wherein the plastic-surgery-unique anthropometric facial measures are selected from among:
the angle between nose-chin and nose-forehead;
nose-upper lip angle;
nose-hook angle;
the backwards angle of the forehead and the nose angle;
the distance between the side eye limbus and the peak point of the eyebrow;
the ratio of the distance between the inward termination points of the eyes to the distance between the eye cavities;
the ratio of the distance between the inward termination points of the eyes to the distance of the nose width; and
the lower and upper nose inclination angles.

15. The matchmaking method of claim 14 the wherein the computing of numerical representations of facial features includes using Gabor kernels to locate features at both standard and non-standard facial points, such features having local maxima in the Gabor-filter images.

16. The matchmaking method of claim 9 wherein the computing of numerical representations of facial features includes using Gabor kernels to locate features at both standard and non-standard facial points, such features having local maxima in the Gabor-filter images.
